(19) United States
(12) Patent Application Publication
(10) Pub. No.: US 2007/0127149 A1
(43) Pub. Date: Jun. 7, 2007

(54) Offset cancellation scheme for perpendicular reader

(75) Inventors: Toru Takeuchi, Kanagawa (JP); Reza Sharifi, Plano, TX (US); Indumini Ranmuthu, Plano, TX (US)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 11/292,479

(22) Filed: Dec. 2, 2005

(51) Int. Cl. G11B 5/02; G11B 5/09

(52) U.S. Cl. 360/68; 360/46

(57) ABSTRACT

A reader input amplifier for a hard disk drive including a gm-amp that compensates for any X-Y imbalance to reduce an excursion, and the time period of the excursion until a final settling point.

### FIELD OF THE INVENTION

The present invention is generally related to hard disk drives, and more particularly to a pre-amp for a hard disk drive circuit.

### BACKGROUND OF THE INVENTION

A hard disk drive typically includes one or more spinning disks stacked above each other on a spindle, a disk drive controller, a rotary actuator and an actuator retract circuit. These elements typically reside in a chassis or housing and are supplied with external cable connectors.

FIG. 1 depicts a conventional hard disk drive 10 having a plurality of disks and associated actuators positionable between an operational position over the disks and a retracted parked position. Each disk 12 is seen to be mounted to a spindle 14 and has associated therewith a head 16 carried by a suspension arm 18. Each head 16 is seen to be positioned via the respective arm 18 across the disk surface as depicted at 20, and is also retractable over a ramp 22 to a parked position distal of the head 22 and over lower portion 24. An actuator control circuit 26 disposed within a housing 28 is coupled to and controls each of the arms 18 via a cable 30.

When there is an X-Y asymmetry in the pre-amplifier, mainly due to device un-matching, the circuit fails out of equilibrium condition and there is no X-Y balancing. Further, when there is the asymmetry, settling from the bias-off (sleep) state to the bias-on (active) state needs more time because the excursion of the output signal becomes larger during the transition.

There is desired an improved pre-amplifier that can better adapt to varying circuit conditions, such as varying betas, to reduce the imbalance, and the time of the imbalance condition until a final settling point.

### SUMMARY OF INVENTION

The present invention achieves technical advantages as a reader input amplifier for a hard disk drive including a gm-amp that compensates for any X-Y imbalance to reduce an excursion, and the time period of the excursion until a final settling point.

### BRIEF DESCRIPTION OF THE DRAWINGS

FIG. 1 is a diagram of a conventional multi-disk hard disk drive;

FIG. 2 is an electrical schematic diagram of a conventional reader amplifier;

FIG. 3 is a waveform diagram of the circuit of FIG. 2 depicting an imbalance condition;

FIG. 4 is an electrical schematic diagram of a feedback amplifier adapted to couple to the circuit of FIG. 2; and

FIG. 5 is a waveform diagram of the circuit of FIG. 4 coupled to the circuit of FIG. 4 depicting an imbalance condition.

### DETAILED DESCRIPTION OF THE PRESENT INVENTION

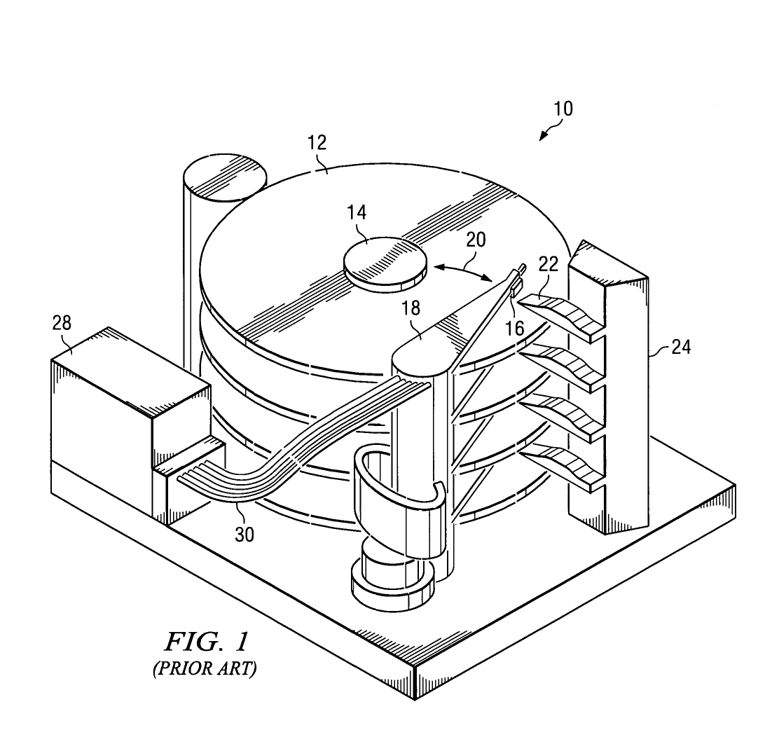

FIG. 1 depicts a conventional hard disk drive 10 having a plurality of disks and associated actuators positionable between an operational position over the disks and a retracted parked position. Each disk 12 is seen to be mounted to a spindle 14 and has associated therewith a head 16 carried by a suspension arm 18. Each head 16 is seen to be positioned via the respective arm 18 across the disk surface as depicted at 20, and is also retractable over a ramp 22 to a parked position distal of the head 22 and over lower portion 24. An actuator control circuit 26 disposed within a housing 28 is coupled to and controls each of the arms 18 via a cable 30.

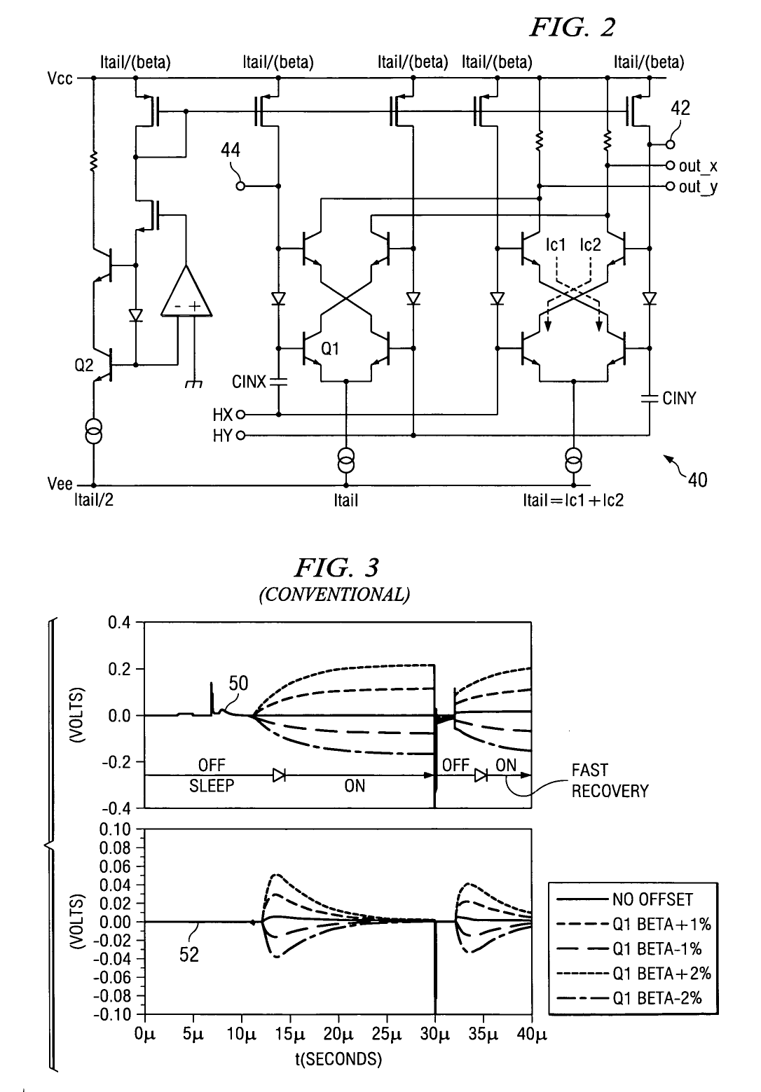

Referring now to FIG. 2, there is shown at 40 an electrical schematic diagram for a conventional reader input amplifier of a hard disk drive pre-amp. A magneto-resistive (MR) head (not shown) is connected to data lines HX and HY. The circuit 40 is biased with a DC current Itail/beta. Data on the hard disk drive creates a magnetic field change as it rotates past and is sensed by the MR head, and thus, the MR head resistance will change, and the resulting sensed voltage change is amplified by this pre-amplifier 40. The DC voltage portion received by the MR head is blocked by a blocking capacitor, and only the AC voltage component is input to the differential amplifier 40. The amplified AC voltage is provided to the next stage at output lines out_x and out_y. The cut-off frequency is determined by capacitor banks CINX and CINY, and the base impedance of the input NPN transistor. The base current of each NPN is Itail/(2*beta), which base current is supplied by the respective upper PMOS current source.

Still referring to FIG. 2, in order to reduce the capacitance of capacitor banks CINX and CINY, the respective collector currents Ic1 and Ic2 are crossed, and the base current corresponding to each is changed by the AC signal and cancelled, whereby the base impedance is very high.

Conventionally, during a change of circuit parameters such as the beta of the NPNs, the PMOS base current sources, or tail current, (Tail) source, there is no equilibrium condition and there is no X-Y balancing.

Referring now to FIG. 3, there is depicted in this graph a simulated waveform of the schematic of FIG. 2. The upper waveform 50 depicts the output of the amplifier 40 across outputs out_x and out_y, and the lower graph 52 depicts the output of the whole read amplifier. It is noted that down stream of this amplifier 40, there is a low-pass filter and gain circuit. When the beta error of NPN transistor Q1 is swept from +2% to −2%, it can been seen in FIG. 3 that the output of the pre-amplifier 40 across outputs out_x and out_y is not balanced. If the amplifier is balanced, the differential output thereacross is 0. As seen in FIG. 3, waveforms 50 and 52 depict large excursions when the beta variation is large, and a significant time period of the excursion, such as when the amplifier is enabled from a sleep-state to an active state.

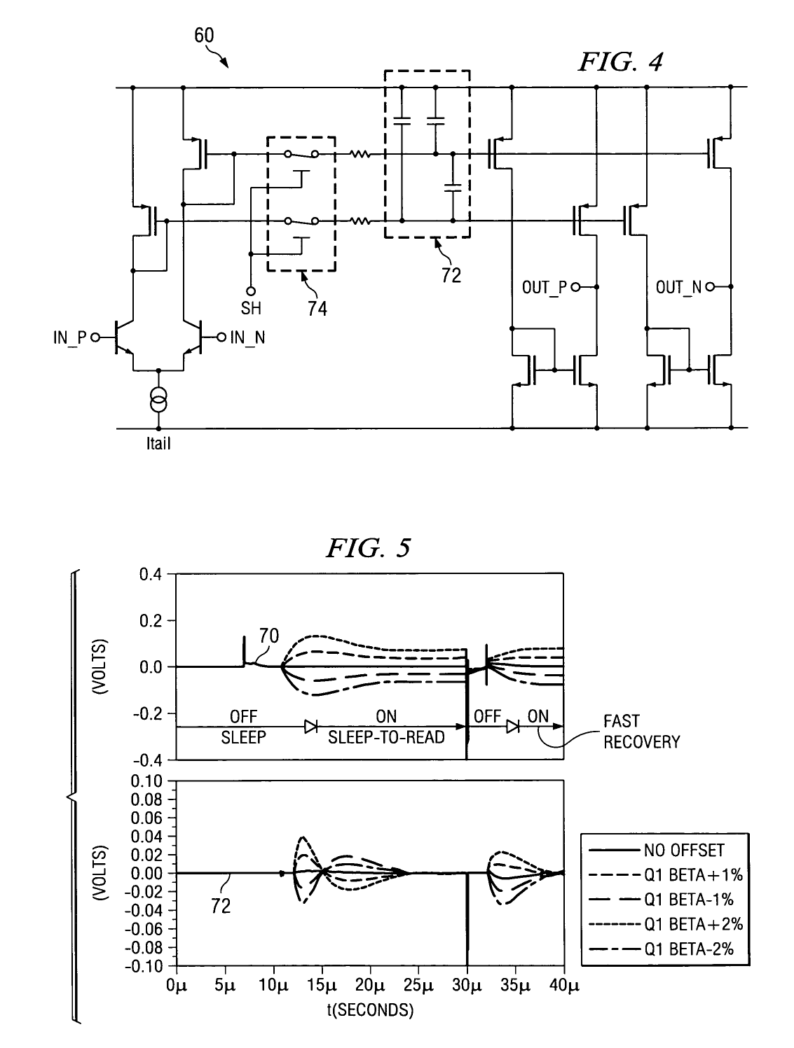

Referring now to FIG. 4, there is shown an electrical schematic of an offset feedback amplifier 60 according to one preferred embodiment of the present invention which significantly reduces this unbalancing issue. Amplifier 60 is seen to include a gm (transconductance)—amp and a low-pass filter. The two inputs (IN_P and IN_N) are connected to the output (out_x and out_y) of the amplifier 40 depicted in FIG. 2, and the output (OUT_P and OUT_N) are connected to the amplifier 40 at 42 and 44, respectively. This gm-amp 60 compensates X-Y imbalance and the excursion becomes smaller, as depicted at 70 and 72 in FIG. 5.

To further make the imbalance settling fast, a boosting circuit can be added such that the bias current of the gm-amp increases during the transient period for fast settling.

The advantages of the gm-amplifier 60 can be appreciated where there is an X-Y imbalance such as when the amplifier 40 processes a transient. Referring to FIG. 2, the beta of the four NPN pairs (8 NPNs total), the PMOS current source providing the base current to each, and the tail current (Itail) source should be matched. Total matching is possible, but is not easy. Advantageously, when the gm-amp 60 depicted in FIG. 4 is coupled to amplifier 40, the X-Y balancing is accomplished via the feedback circuit 60. Advantageously, the gm-amp balancing according to the present invention is not so difficult because the device sizes are not large, and thus a large Itail current is not necessary.

Referring to FIG. 5, a further advantage of the present invention can be appreciated. Comparing the differential amplifier 40 in FIG. 2 and the amplifier 40 including the gm-amplifier 60 when disabled and put into the sleep mode, and when subsequently enabled by a sleep-to-read transient, it can be appreciated that utilizing the gm-amplifier 60 according to the present invention realizes an amplifier having a differential output that quickly goes to a settling point. In the off-period before a fast-recovery, both amplifiers 40 and 60 are disabled but the settling point is fed to a sample-and-hold circuit 72, whereby switches 74 are off. When the amplifiers are turned on, the initial point is close to the final settling point, and the settling time and excursion becomes shorter and smaller, as depicted in FIG. 5.

It is noted that the differential amplifier 40 of FIG. 2 could also be made from PNP transistors, and the gm-amp input 60 of the amplifier depicted in FIG. 4 can also be made from PNP and MOS transistors if desired.

Though the invention has been described with respect to a specific preferred embodiment, many variations and modifications will become apparent to those skilled in the art upon reading the present application. It is therefore the intention that the appended claims be interpreted as broadly as possible in view of the prior art to include all such variations and modifications. This invention can also be utilized in other signal amplifiers, and is not limited to hard-disk-drive applications.

What is claimed is:

1. A pre-amplifier configured to drive a hard disk drive head, comprising:
a pre-amplifier circuit configured to receive a differential signal from the head and provide an amplified differential output signal, the pre-amplifier circuit comprising a plurality of paired transistors each configured to conduct a tail current; and
a transconductance (gm) amplifier coupled to the pre-amplifier circuit and configured to reduce an imbalance between the tail currents.

2. The pre-amplifier as specified in claim 1 wherein the gm amplifier is configured to reduce the imbalance when a beta of the transistors vary.

3. The pre-amplifier as specified in claim 2 wherein the gm amplifier is configured to reduce a time period of the imbalance upon the pre-amplifier being enabled.

4. The pre-amplifier as specified in claim 3 wherein the gm amplifier is configured to reduce the time period of the imbalance when the pre-amplifier changes from a sleep-state to an active state.

5. The pre-amplifier as specified in claim 1 wherein the gm amplifier comprises a feedback circuit.

6. The pre-amplifier as specified in claim 5 wherein the gm amplifier comprises an offset said feedback circuit.

7. The pre-amplifier as specified in claim 5 wherein the feedback circuit comprises at least one capacitor selectively coupled to the pre-amplifier circuit during the imbalance.

8. The pre-amplifier as specified in claim 7 wherein the capacitor comprises a bank of capacitors.

9. The pre-amplifier as specified in claim 1 wherein a first capacitor is selectively coupled to one said pair of transistors during the imbalance, and a second capacitor is selectively coupled to another said pair of transistors during the imbalance.

10. The pre-amplifier as specified in claim 1 wherein the differential output signal has a reduced imbalance and time period during the imbalance.
